(19) United States
(12) Patent Application Publication
(10) Pub. No.: US 2025/0139939 A1
(43) Pub. Date: May 1, 2025

(54) IMAGE MATCHING APPARATUS, IMAGE MATCHING METHOD, AND NON-TRANSITORY COMPUTER-READABLE STORAGE MEDIUM

(71) Applicant: NEC Corporation, Minato-ku, Tokyo (JP)

(72) Inventors: Royston RODRIGUES, Tokyo (JP); Masahiro Tani, Tokyo (JP)

(73) Assignee: NEC Corporation, Minato-ku, Tokyo (JP)

(21) Appl. No.: 18/836,860

(22) PCT Filed: Mar. 25, 2022
(86) PCT No.: PCT/JP2022/014655

§ 371 Date: Aug. 8, 2024

(51) Int. Cl. G06V 10/75; G06V 10/40; G06V 10/74; G06V 20/10

(52) U.S. Cl. CPC G06V 10/751; G06V 10/40; G06V 10/761; G06V 20/10

(57) ABSTRACT

An image matching apparatus acquires a ground-view image, an aerial-view image, and class information. The class information indicates a distribution of classes of objects on the ground-view image, the aerial-view image, or both. The image matching apparatus-extracts features from the ground-view image to compute a ground image feature, extracts features from the aerial-view image to compute an aerial image feature, and extracts features from the class information to compute a class feature. The image matching apparatus determines whether or not the ground-view image and the aerial-view image match each other based on the ground image feature, the aerial image feature, and the class feature.

### TECHNICAL FIELD

The present disclosure generally relates to an image matching apparatus, an image matching method, and a non-transitory computer-readable storage medium.

### BACKGROUND ART

A computer system that performs ground-to-aerial cross-view matching (matching between a ground-view image and an aerial-view image) has been developed. For example, NPL1 discloses a system comprising a set of CNNs (Convolutional Neural Networks) to match a ground-view image against an aerial-view image. Specifically, one of the CNNs acquires a set of a ground-view image and orientation maps that indicate orientations (azimuth and altitude) for each location captured in the ground-view image, and extracts features therefrom. The other one acquires a set of an aerial-view image and orientation maps that indicate orientations (azimuth and range) for each location captured in the aerial-view image, and extracts features therefrom. Then, the system determines whether the ground-view image matches the aerial-view image based on the extracted features.

### CITATION LIST

### Non Patent Literature

NPL1: Liu Liu and Hongdong Li, “Lending Orientation to Neural Networks for Cross-view Geo-localization”, [online], Mar. 29, 2019, [retrieved on 2021 Sep. 24], retrieved from <arXiv, https://arxiv.org/pdf/1903.12351>

NPL2: Jeffrey Pennington, Richard Socher, and Christopher D. Manning, “GloVe: Global Vectors for Word Representation”, Proceedings of the 2014 Conference on Empirical Methods in Natural Language Processing (EMNLP), pages 1532-1543 Oct. 25, 2014

NPL3: Tomas Mikolov, Ilya Sutskever, Kai Chen, Greg Corrado, and Jeffrey Dean, “Distributed Representations of Words and Phrases and their Compositionality”, [online], Oct. 16, 2013, [retrieved on 2022 Mar. 10], retrieved from <arXiv, https://arxiv.org/pdf/1310.4546.pdf>

### SUMMARY OF INVENTION

### Technical Problem

In NPL1, it is not considered to extract features from images other than RGB images or their orientation maps. An objective of the present disclosure is to provide a novel technique to determine whether or not a ground-view image and an aerial-view image match each other.

### Solution to Problem

The present disclosure provides at least one memory that is configured to store instructions and the at least one processor. The at least one processor is configured to execute the instructions to: acquire a ground-view image, an aerial-view image, and class information that indicates a distribution of classes of objects on the ground-view image, the aerial-view image, or both; extract features from the ground-view image to compute a ground image feature; extract features from the aerial-view image to compute an aerial image feature; extract features from the class information to compute a class feature; and determine whether or not the ground-view image and the aerial-view image match each other based on the ground image feature, the aerial image feature, and the class feature.

The present disclosure further provides an image matching method that is performed by a computer. The image matching method comprises: acquiring a ground-view image, an aerial-view image, and class information that indicates a distribution of classes of objects on the ground-view image, the aerial-view image, or both; extracting features from the ground-view image to compute a ground image feature; extracting features from the aerial-view image to compute an aerial image feature; extracting features from the class information to compute a class feature; and determining whether or not the ground-view image and the aerial-view image match each other based on the ground image feature, the aerial image feature, and the class feature.

The present disclosure further provides a non-transitory computer-readable storage medium storing a program. The program causes a computer to execute: acquiring a ground-view image, an aerial-view image, and class information that indicates a distribution of classes of objects on the ground-view image, the aerial-view image, or both; extracting features from the ground-view image to compute a ground image feature; extracting features from the aerial-view image to compute an aerial image feature; extracting features from the class information to compute a class feature; and determining whether or not the ground-view image and the aerial-view image match each other based on the ground image feature, the aerial image feature, and the class feature.

According to the present disclosure, it is possible to provide a novel technique to determine whether a ground-view image and an aerial-view image match each other.

### BRIEF DESCRIPTION OF DRAWINGS

FIG. 1 illustrates an overview of an image matching apparatus.

FIG. 2 illustrates an example of the ground-view image and the aerial-view image.

FIG. 3 is a block diagram illustrating an example of a functional configuration of the image matching apparatus.

FIG. 4 is a block diagram illustrating an example of a hardware configuration of the image matching apparatus.

FIG. 5 shows a flowchart illustrating an example flow of processes performed by the image matching apparatus.

FIG. 6 illustrates a geo-localization system that includes the image matching apparatus.

FIG. 7 illustrates an example of a part of the structure of the image matching apparatus to compare the ground feature and the aerial feature.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predetermined information (e.g., a predetermined value or a predetermined threshold) is stored in advance in a storage device to which a computer using that information has access unless otherwise described.

### FIRST EXAMPLE EMBODIMENT

### Overview

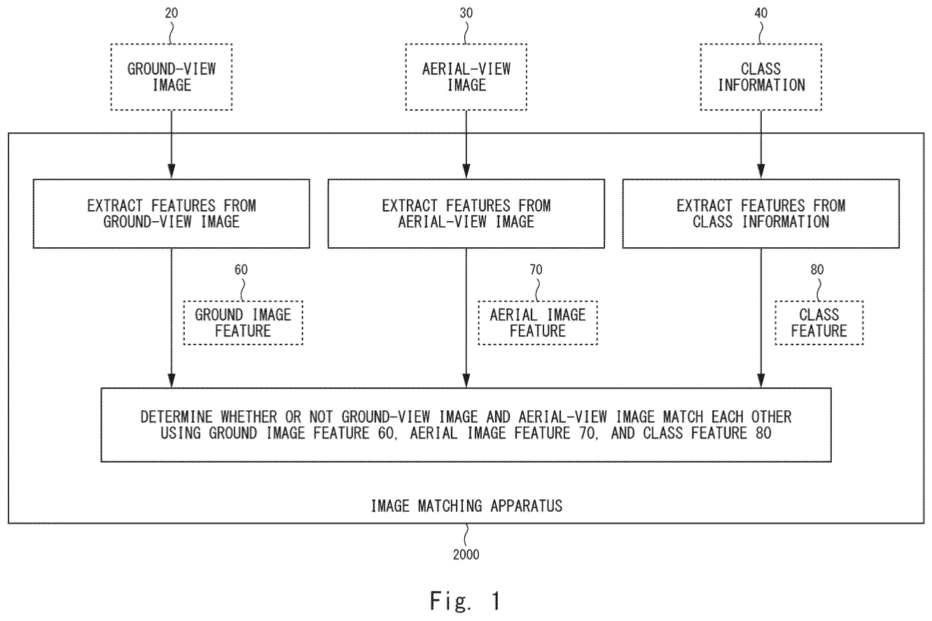

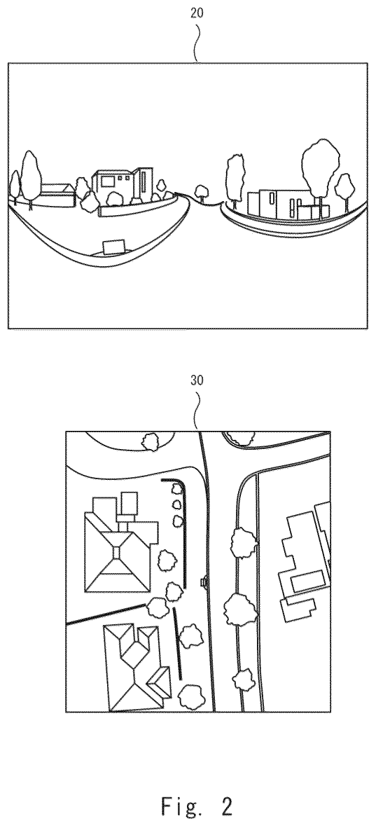

FIG. 1 illustrates an overview of an image matching apparatus 2000 of the first example embodiment. The image matching apparatus 2000 functions as a discriminator that performs matching between a ground-view image 20 and an aerial-view image 30 (so-called ground-to-aerial cross-view matching). FIG. 2 illustrates an example of the ground-view image 20 and the aerial-view image 30.

The ground-view image 20 is a digital image that includes a ground view of a place, e.g., an RGB image of ground scenery. For example, the ground-view image 20 is generated by a ground camera that is held by a pedestrian or installed in a car. The ground-view image may be panoramic (having 360-degree field of view), or may have limited (less than 360-degree) field of view.

The aerial-view image 30 is a digital image that includes a top view of a place, e.g., an RGB image of aerial scenery. For example, the aerial-view image 30 is generated by an aerial camera installed in a drone, an air plane, or a satellite.

In addition to the ground-view image 20 and the aerial-view image 30, the image matching apparatus 2000 uses a class information 40, which indicates a distribution of classes (such as “building”, “road”, “sidewalk”, etc.) of objects on the ground-view image 20, the aerial-view image 30, or both. The class information 40 may include a segmented image each of whose pixel represents the class of the object that is captured in a corresponding region (i.e., one or more corresponding pixels) of an original image (i.e., the ground-view image 20 or the aerial-view image 30).

The data included in the class information 40 is not limited to the segmented image. Additionally or alternatively, the class information 40 may include a keyword matrix, which is a matrix each of whose element indicates a keyword vector that represents the class of object that is captured in a corresponding region (i.e., one or more corresponding pixels) of an original image (i.e., the ground-view image 20 or the aerial-view image 30).

It is noted that, as described in detail later, the class information 40 may be generated in the image matching apparatus 2000 instead of being acquired from the outside of the image matching apparatus 2000.

The image matching apparatus 2000 extracts features from each of the acquired data: the ground-view image 20, the aerial-view image 30, and the class information 40. Specifically, the image matching apparatus 2000 extracts features from the ground-view image 20 to generate a ground image feature 60. The image matching apparatus 2000 extracts features from the aerial-view image 30 to generate an aerial image feature 70. The image matching apparatus 2000 extracts features from the class information 40 to generate a class feature 80.

In the case where the class information 40 includes data that represents a class distribution on the ground-view image 20, the class feature 80 includes features extracted from that data, which will be called “ground class feature”. The ground class feature represents features of the class distribution on the ground-view image 20. In the case where the class information 40 includes data that represents a class distribution on the aerial-view image 30, the class feature 80 includes features extracted from that data, which will be called “aerial class feature”. The aerial class feature represents features of the class distribution on the aerial-view image 30.

After the extraction of the above-mentioned features, the image matching apparatus 2000 determines whether or not the ground-view image 20 and the aerial-view image 30 match each other using the ground image feature 60, the aerial image feature 70, and the class feature 80.

### Example of Advantageous Effect>

According to the image matching apparatus 2000 of the first example embodiment, whether or not the ground-view image 20 and the aerial-view image 30 match each other is determined using not only features extracted from the ground-view image 20 and the aerial-view image 30 but also the features extracted from the class information 40. By using the features extracted from the class information 40, i.e., the class feature 80, it is possible to compare the ground-view image 20 and the aerial-view image 30 based on not only their similarity in appearance but also their similarity in class distribution. Thus, comparing with the case where the class feature 80 is not used, the image matching apparatus 2000 can perform the ground-to-aerial cross-view matching more accurately.

Hereinafter, more detailed explanation of the image matching apparatus 2000 will be described.

### Example of Functional Configuration

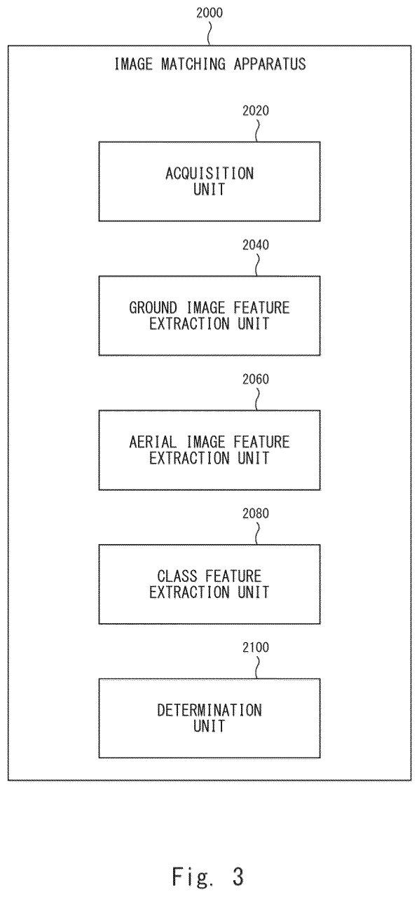

FIG. 3 is a block diagram showing an example of the functional configuration of the image matching apparatus 2000. The image matching apparatus 2000 includes an acquisition unit 2020, a ground image feature extraction unit 2040, an aerial image feature extraction unit 2060, a class feature extraction unit 2080, and a determination unit 2100.

The acquisition unit 2020 acquires the ground-view image 20, the aerial-view image 30, and the class information 40. The ground image feature extraction unit 2040 extracts features from the ground-view image 20, thereby obtaining the ground image feature 60. The aerial image feature extraction unit 2060 extracts features from the aerial-view image 30, thereby obtaining the aerial image feature 70. The class feature extraction unit 2080 extracts features from the class information 40, thereby obtaining the class feature 80. The determination unit 2100 determines whether or not the ground-view image 20 and the aerial-view image 30 match each other using the ground image feature 60, the aerial image feature 70, and the class feature 80.

### Example of Hardware Configuration

The image matching apparatus 2000 may be realized by one or more computers. Each of the one or more computers may be a special-purpose computer manufactured for implementing the image matching apparatus 2000, or may be a general-purpose computer like a personal computer (PC), a server machine, or a mobile device. The image matching apparatus 2000 may be realized by installing an application in the one or more computers. The application is implemented with a program that causes the one or more computers to function as the image matching apparatus 2000. In other words, the program is an implementation of the functional units of the image matching apparatus 2000.

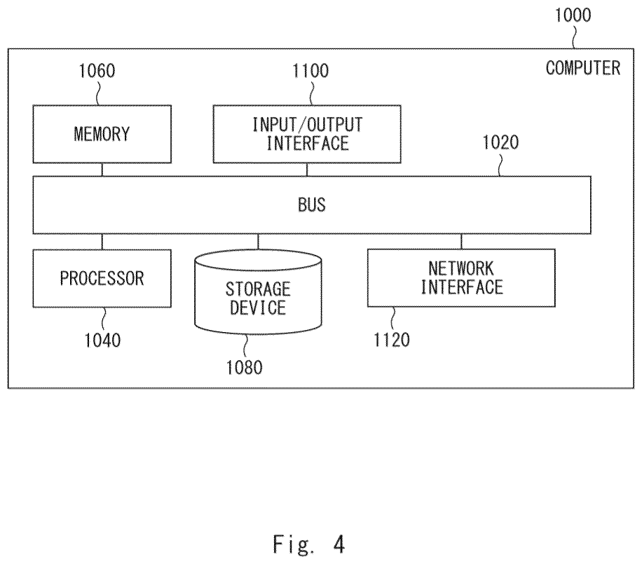

FIG. 4 is a block diagram illustrating an example of the hardware configuration of a computer 1000 realizing the image matching apparatus 2000. In FIG. 4, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The storage device 1080 may store the program mentioned above. The processor 1040 reads the program from the storage device 1080, and executes the program to realize each functional unit of the image matching apparatus 2000.

The hardware configuration of the computer 1000 is not restricted to that shown in FIG. 4. For example, as mentioned-above, the image matching apparatus 2000 may be realized by plural computers. In this case, those computers may be connected with each other through the network.

### Flow of Process

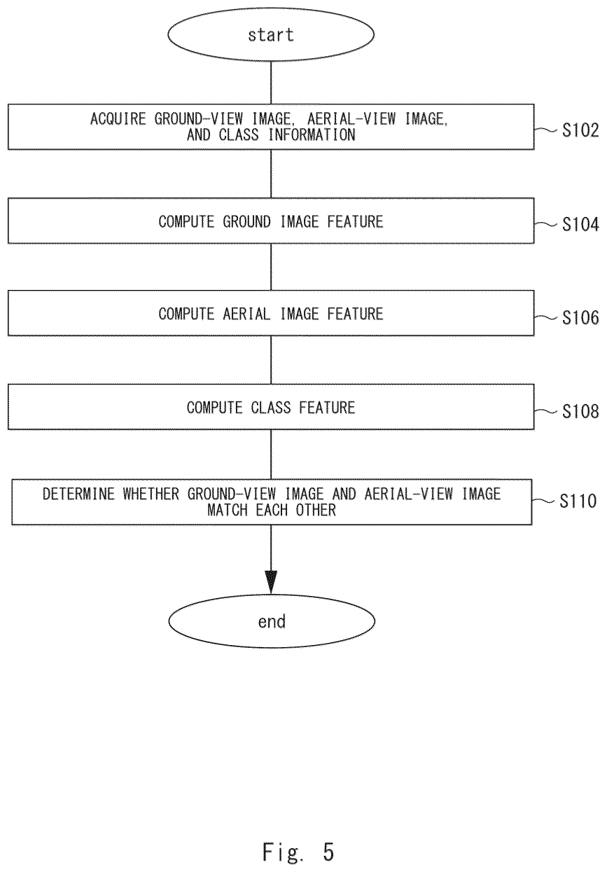

FIG. 5 shows a flowchart illustrating an example flow of processes performed by the image matching apparatus 2000. The acquisition unit 2020 acquires the ground-view image 20, the aerial-view image 30, and the class information 40 (S102). The ground image feature extraction unit 2040 extracts features from the ground-view image 20 to compute the ground image feature 60 (S104). The aerial image feature extraction unit 2060 extracts features from the aerial-view image 30 to compute the aerial image feature 70 (S106). The class feature extraction unit 2080 extracts features from the class information 40 to compute the class feature 80 (S108). The determination unit 2100 determines whether the ground-view image 20 and the aerial-view image 30 match each other using the ground image feature 60, the aerial image feature 70, and the class feature 80 (S110).

### Example Application of Image Matching Apparatus 2000

There are various possible applications of the image matching apparatus 2000. For example, the image matching apparatus 2000 can be used as a part of a system (hereinafter, a geo-localization system) that performs image geo-localization. Image geo-localization is a technique to determine the place at which an input image is captured. The geo-localization system 200 may be implemented by one or more arbitrary computers such as ones depicted in FIG. 4. It is noted that the geo-localization system is merely an example of the application of the image matching apparatus 2000, and the application of the image matching apparatus 2000 is not restricted to being used in the geo-localization system.

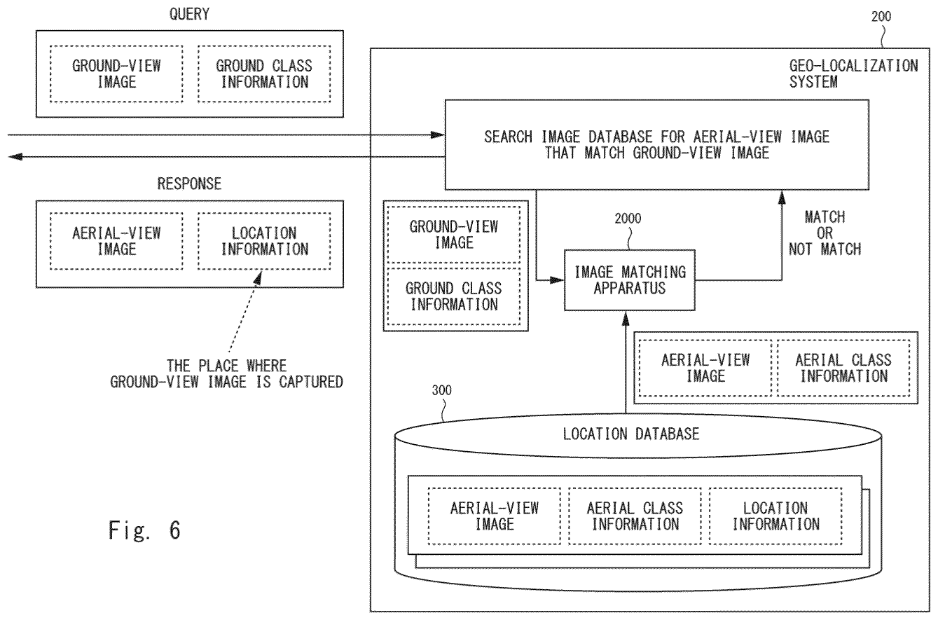

FIG. 6 illustrates a geo-localization system 200 that includes the image matching apparatus 2000. The geo-localization system 200 includes the image matching apparatus 2000 and the location database 300. The location database 300 includes a plurality of aerial-view images to each of which location information is attached. An example of the location information may be GPS (Global Positioning System) coordinates of the place captured in the center of the corresponding aerial-view image.

The geo-localization system 200 receives a query that includes a set of a ground-view image and ground class information from a client (e.g., user terminal). The ground class information is an embodiment of the class information 40 that indicates the class distribution in the ground-view image, such as the segmented image of the ground-view image 20. Then, the geo-localization system 200 searches the location database 300 for the aerial-view image that matches the ground-view image in the received query, thereby determining the place at which the ground-view image is captured. Specifically, until the aerial-view image that matches the ground-view image in the query is detected, the geo-localization system 200 repeatedly executes to: acquire one of the aerial-view images from the location database 300; input the set of the ground-view image and the ground class information and a set of the acquired aerial-view image and aerial class information into the image matching apparatus 2000; and determine whether or not the output of the image matching apparatus 2000 indicates that the ground-view image matches the aerial-view image. It is noted that the aerial class information is an embodiment of the class information 40 that indicates the class distribution in the aerial-view image, such as the segmented image of the aerial-view image 30.

By repeatedly executing the above-mentioned processes, the geo-localization system 200 can find the aerial-view image that includes the place at which the ground-view image is captured. Since the detected aerial-view image is associated with the location information such as the GPS coordinates, the geo-localization system 200 can recognize that where the ground-view image is captured is the place that is indicated by the location information associated with the aerial-view image that matches the ground-view image.

In the example depicted by FIG. 6, both the class distribution in the ground-view image 20 and that in the aerial-view image 30 are taken into consideration. However, in another implementation, the image matching apparatus 2000 may use either one of them in some implementations.

In the example depicted by FIG. 6, the ground class information is included in the query. However, in another implementation, the gel-localization system 200 may receive a query that does not include the ground class information. In this case, the geo-localization system 200 may generate the ground class information from the ground-view image 20 by performing, for example, semantic segmentation on the ground-view image 20.

In the example depicted by FIG. 6, the aerial class information is stored in the location database 300 in association with the aerial-view image 30. However, in another implementation, the location database 300 may not store the aerial class information. In this case, the geo-localization system 200 may generate the aerial class information from the aerial-view image 30 by performing, for example, semantic segmentation on the aerial-view image 30.

It is noted that the ground-view image and the aerial-view image are used in an opposite way in the geo-localization system 200. In this case, the location database 300 stores a plurality of ground-view images to each of which location information is attached. The geo-localization system 200 receives a query including an aerial-view image, and searches the location database 300 for the ground-view image that matches the aerial-view image in the query, thereby determining the location of the place that is captured in the aerial-view image.

### As to Class Information

The class information 40 may include one or more pieces of information that represents the distribution of classes of objects on the ground-view image 20, the aerial-view image 30, or both. As mentioned above, the class information 40 may include a segmented image or a keyword matrix. Hereinafter, each of these examples of the class information 40 will be explained.

### Segmented Image

The segmented image is an image each of whose pixel represents, by its color (i.e., pixel value), a class of the object that is captured in the corresponding region of the original image from which the segmented image is generated. Suppose that there are five given classes “sky”, “building”, “road”, “sidewalk”, and “others”, and the colors “yellow”, “blue”, “green”, “red”, and “gray” are assigned to these classes in this order. In this case, for example, when some pixels in the original image captures the sky, the corresponding pixels in the segmented image are filled with the yellow. Similarly, when some pixels in the original image captures the building, the corresponding pixels in the segmented image are filled with the blue.

It is noted that the dimensions (i.e., width and height) of the segmented image may be same as those of the original image, or may be different from those of the original image. In the former case, the pixel of the segmented image indicates the class of the object captured in the corresponding pixel of the original image.

In the latter case, the pixel of the segmented image indicates the class of the object captured in the corresponding pixels of the original image. For example, the segmented image may be generated so that each of its pixel corresponds to a region with N×M pixels of the original image, wherein N, M, or both are greater than 1.

The segmented image may be generated by performing semantic segmentation on the original image. There are various well-known ways to perform semantic segmentation on an image, and any one of those ways can be applied to generate the segmented image of the ground-view image 20, the aerial-view image 30, or both. In addition, in the case where the dimensions of the segmented image are less than those of the original image, image matching apparatus 2000 may perform subsampling (e.g., average pooling or max pooling) on the segmented image to reduce its dimensions. It is noted that it is not necessarily the image matching apparatus 2000 that generates the segmented image.

### Keyword Matrix

The keyword matrix is a matrix each of whose element indicates a vector named “keyword vector” that represents a class of the object that is captured in the corresponding region of the original image from which the keyword matrix is generated. Suppose that there are five given classes “sky”, “building”, “road”, “sidewalk”, and “others”, and one-hot vectors (0,0,0,0,1), (0,0,0,1,0), (0,0,1,0,0), (0,1,0,0,0), and (1,0,0,0,0) are assigned to these classes in this order. In this case, for example, when some pixels in the original image captures the sky, the corresponding elements of the keyword matrix indicate (0,0,0,0,1). Similarly, when some pixels in the original image captures the building, the corresponding elements of the keyword matrix indicate (0,0,0,1,0).

It is noted that, like the segmented image, the width and height of the keyword matrix may be same as those of the original image, or may be different from those of the original image. In the former case, the element of the keyword matrix indicates a keyword vector that represents the class of the object captured in the corresponding pixel of the original image.

In the latter case, the element of the keyword matrix indicates a keyword vector that represents the class of the object captured in the corresponding pixels of the original image. For example, the keyword matrix may be generated so that each of its element corresponds to a region with N×M pixels of the original image, wherein N, M, or both are greater than 1.

The keyword vector is not limited to one-hot vector. For example, a set of the keyword vectors is defined with knowledge about the classes (e.g., similarity among classes). The knowledge may be embedded in distance between the keyword vectors. For example, a set of the keyword vectors is defined so that a degree of similarity between classes is represented by the distance between the keyword vectors of those classes. Conceptually, the more similar two classes are, the shorter the distance between their keyword vectors is. Such a set of keywords can be defined with a technique disclosed by, for example, NPL2 or NPL3.

To generate the keyword matrix, the image matching apparatus 2000 first determines the class of the object captured by each pixel of the original image. This determination may be done with semantic segmentation. Then, for each pixel, the image matching apparatus 2000 assigns to that pixel a keyword vector representing the class of the object captured by that pixel. In addition, in the case where the dimensions of the keyword matrix are less than those of the original image, the image matching apparatus 2000 may perform subsampling (e.g., average pooling or max pooling) on the keyword matrix to reduce its dimensions. It is noted that it is not necessarily the image matching apparatus 2000 that generates the keyword matrix.

### Acquisition of Data: S102

The acquisition unit 2020 acquires the ground-view image 20, the aerial-view image 30, and the class information 40 (S102). There are various ways to acquire those data. In some implementations, the acquisition unit 2020 may receive those data sent from another computer. In other implementations, the acquisition unit 2020 may retrieve those data from a storage device to which it has access.

Regarding the class information 40, the image matching apparatus 2000 may generate them based on the ground-view image 20, the aerial-view image 30, or both, and the acquisition unit 2020 obtains the class information 40 generated inside the image matching apparatus 2000. Concrete ways of generating the class information 40 have been mentioned above.

### Extraction of Ground Image Feature 60: S104

The ground image feature extraction unit 2040 extracts features from the ground-view image 20 to compute the ground image feature 60 (S104). There exist various ways to extract features from an image, and any one of them may be employed to form the ground image feature extraction unit 2040. For example, the ground image feature extraction unit 2040 may be realized by a machine learning-based model, such as a neural network. More specifically, a feature extraction layer of CNN (Convolutional Neural Network) may be employed to form the ground image feature extraction unit 2040.

### Extraction of Aerial Image Feature 70: S106

The aerial image feature extraction unit 2060 extracts features from the aerial-view image 30 to compute the aerial image feature 70 (S106). As mentioned above, there exist various ways to extract features from an image. Thus, any one of them may be employed to form the aerial image feature extraction unit 2060. For example, the aerial image feature extraction unit 2060 may be realized by a machine learning-based model, such as a neural network. More specifically, a feature extraction layer of CNN (Convolutional Neural Network) may be employed to form the aerial image feature extraction unit 2060.

### Extraction of Class Feature 80: S108

The class feature extraction unit 2080 extracts features from the class information 40 to compute the class feature 80 (S108). The features of the class information 40 may be extracted from the class information 40 in a way similar to the way with which the ground image feature 60 is extracted from the ground-view image 20 or the way with which the aerial image feature 70 is extracted from the aerial-view image 30. For example, the class feature extraction unit 2080 may be realized by a machine learning-based model, such as a neural network.

It is noted that, when the class information 40 is configured to include multiple types of information, such as the segmented image and the keyword matrix of the ground-view image 20, the class information 40 includes a feature extractor for each of those data.

### Matching of Ground-View Image 20 and Aerial-View Image 30: S110

The determination unit 2100 determines whether or not the ground-view image 20 and the aerial-view image 30 match each other using the ground image feature 60, the aerial image feature 70, and the class feature 80 (S110). Specifically, the determination unit 2100 performs the determination by comparing features (called “ground feature”) that relate to the ground-view image 20 and features (called “aerial feature”) that relate to the aerial-view image 30. When the class feature 80 includes the ground class feature, the determination unit 2100 computes a combined feature of the ground image feature 60 and the ground class feature, and uses the computed feature as the ground feature. On the other hand, when the class feature 80 does not include the ground class feature, the determination unit 2100 uses the ground image feature 60 as the ground feature. Similarly, when the class feature 80 includes the aerial class feature, the determination unit 2100 computes a combined feature of the aerial image feature 70 and the aerial class feature, and uses the computed feature as the aerial feature. On the other hand, when the class feature 80 does not include the aerial class feature, the determination unit 2100 uses the aerial image feature 70 as the aerial feature.

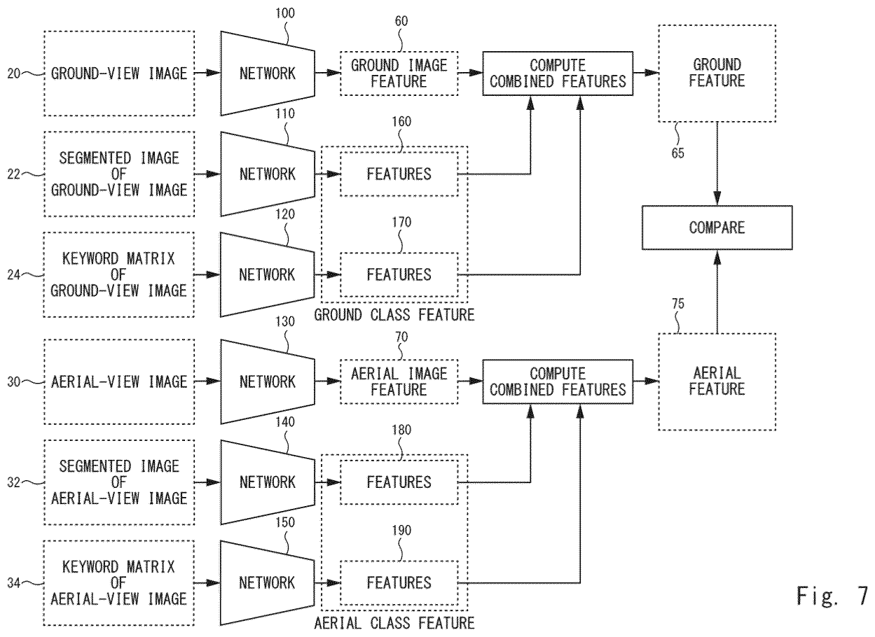

FIG. 7 illustrates an example of a part of the structure of the image matching apparatus 2000 to compare the ground feature and the aerial feature. In this example, the class information 40 includes the segmented image and the keyword matrix for both of the ground-view image 20 and the aerial-view image 30.

The image matching apparatus 2000 includes the networks 100, 110, 120, 130, 140, and 150. The network 100, which is included in the ground image feature extraction unit 2040, extracts the ground image feature 60 from the ground-view image 20. The network 110, which is included in the class feature extraction unit 2080, extracts features 160 from the segmented image 22 of the ground-view image 20. The network 120, which is included in the class feature extraction unit 2080, extracts features 170 from the keyword matrix 24 of the ground-view image 20. In this case, the ground class feature includes the features 160 and 170. Then, the ground image feature 60, the features 160, and the features 170 are combined with each other to compute the ground feature 65.

It is noted that there are various ways to combine multiple features, and any one of them can be applied to combine the ground image feature 60, the features 160, and the features 170 to compute the ground feature 65. For example, the features 160 and 170 are concatenated with the ground image feature 60 to compute the ground feature 65. In another example, the ground image feature 60, the features 160, and the features 170 are fed into a feature extractor, such as a neural network, and the output from this feature extractor is used as the ground feature 65.

The aerial feature may be computed in a way similar to the way to compute the ground feature. Specifically, the network 130, which is included in the aerial image feature extraction unit 2060, extracts the aerial image feature 70 from the aerial-view image 30. The network 140, which is included in the class feature extraction unit 2080, extracts features 180 from the segmented image 32 of the aerial-view image 30. The network 150, which is included in the class feature extraction unit 2080, extracts features 190 from the keyword matrix 34 of the aerial-view image 30. In this case, the aerial class feature includes the features 180 and 190. Then, the aerial image feature 70, the features 180, and the features 190 are combined with each other to compute the aerial feature 75. It is noted that the aerial image feature 70, the features 180, and the features 190 can be combined in a way similar to the way of combining the ground image feature 60, the features 160, and the features 170.

After the combination of the features, the determination unit 2100 may compute a similarity score, which represents the similarity between the ground feature and the aerial feature. There are various metrics to quantify a similarity between features, and any one of them can be used to compute the similarity score. For example, the similarity score may be computed as one of various types of distance (e.g., L2 distance), correlation, cosine similarity, or NN (neural network) based similarity between the ground feature and the aerial feature. The NN based similarity is the degree of similarity computed by a neural network that is trained to compute the degree of similarity between two input data (in this case, the ground feature and the aerial feature).

The determination unit 2100 determines whether or not the ground-view image 20 and the aerial-view image 30 match each other based on the similarity score computed for them. Conceptually, the higher the degree of similarity between the ground feature and the aerial feature is, the higher the possibility of that the ground-view image 20 and the aerial-view image 30 match each other. Therefore, for example, the determination unit 2100 determines whether or not the similarity score is equal to or larger than a predefined threshold. If the similarity score is equal to or larger than the predefined threshold, the determination unit 2100 determines that the ground-view image 20 and the aerial-view image 30 match each other. On the other hand, if the similarity score is less than a predefined threshold, the determination unit 2100 determines that the ground-view image 20 and the aerial-view image 30 do not match each other.

It is noted that, in the case mentioned above, the similarity score is assumed to become larger as the degree of similarity between the ground feature and the aerial feature becomes higher. Thus, if a metric such as a distance with which a value computed for the ground feature and the aerial feature becomes less as the degree of similarity therebetween becomes higher is used, the similarity score may be defined as the reciprocal of the value computed for the ground feature and the aerial feature.

In another example, in the case where the similarity score becomes less as the degree of similarity between the ground feature and the aerial feature becomes higher, the determination unit 2100 may determine whether the similarity score is equal to or less than a predefined threshold. If the similarity score is equal to or less than the predefined threshold, the determination unit 2100 determines that the ground-view image 20 and the aerial-view image 30 match each other. On the other hand, if the similarity score is larger than the predefined threshold, the determination unit 2100 determines that the ground-view image 20 and the aerial-view image 30 do not match each other.

### Output from Image Matching Apparatus 2000

The image matching apparatus 2000 may output information (hereinafter, output information) indicating a result of the determination. For example, the output information may indicate whether or not the ground-view image 20 and the aerial-view image 30 match each other. In addition, as explained with referring to FIG. 6, the output information may further include the location information that indicates the location at which the queried image (the ground-view image 20 or the aerial-view image 30) is captured.

There are various ways to output the output information. For example, the image matching apparatus 2000 may put the output information into a storage device. In another example, the image matching apparatus 2000 may output the output information to a display device so that the display device displays the contents of the output information. In another example, the image matching apparatus 2000 may output the output information to another computer, such as one included in the geo-localization system 200 shown in FIG. 6.

### Training of Models

As mentioned above, the image matching apparatus 2000 may include one or more machine learning-based models, such as neural networks. For example, as explained with referring to FIG. 7, the ground image feature extraction unit 2040, the aerial image feature extraction unit 2060, and the class feature extraction unit 2080 may include neural networks. When the image matching apparatus 2000 is implemented with the machine learning-based models, those models are trained the using training datasets in advance of an operation phase of the image matching apparatus 2000.

In some implementations, a computer (hereinafter, training apparatus) that trains the models may repeatedly perform: computing a loss (e.g., a triplet loss or contrastive loss) using a training dataset; and updates trainable parameters of the models based on the computed loss. It is noted that the training apparatus may be implemented in the computer 1000 in which the image matching apparatus 2000 is implemented, or may be implemented in other computers. In the former case, it can be described that the image matching apparatus 2000 also have functions of the training apparatus explained later. In the latter case, the training apparatus may be implemented using one or more computers whose hardware configuration can be exemplified by FIG. 4, similar to the image matching apparatus 2000.

When using a triplet loss to train the models, the training dataset may include an anchor image, a positive example image, and a negative example image. The positive example image is an image of a type (ground-view or aerial-view) different from the anchor image, and matches the anchor image. The negative example image is an image of a type different from the anchor image but same as the positive example image, and does not match the anchor image. In the case where the training dataset includes a ground-view image as the anchor image, it includes an aerial-view image that matches the anchor image as the positive example image and another aerial-view image that does not match the anchor image as the negative example image. On the other hand, in the case where the training dataset includes an aerial-view image as the anchor image, it includes a ground-view image that matches the anchor image as the positive example image and another ground-view image that does not match the anchor image as the negative example image.

The training dataset may also include the class information for each of the anchor image, the positive example image, and the negative example image. Specifically, the training dataset may include the segmented image and the keyword matrix for each of the anchor image, the positive example image, and the negative example image. However, as mentioned above, the class information can be generated instead of acquiring from the outside.

The training apparatus uses the ground image feature extraction unit 2040, the aerial image feature extraction unit 2060, and the class feature extraction unit 2080 to obtain features from the anchor image, the positive example image, the negative example image, and the class information in the training dataset. Suppose that the image matching apparatus 2000 has the structure depicted by FIG. 7. In addition, suppose that the training dataset includes a ground-view image as the anchor image. In this case, the training apparatus inputs the anchor image, the segmented image of the anchor image, and the keyword matrix of the anchor image into the network 100, 110, and 120, respectively. As a result, the training apparatus obtains the ground feature of the anchor image that is a combination of the ground image feature of the anchor image, the features of the segmented image of the anchor image, and the features of the keyword matrix of the anchor image.

In addition, the training apparatus inputs the positive example image, the segmented image of the positive example image, and the keyword matrix of the positive example image into the network 130, 140, and 150, respectively. As a result, the training apparatus obtains the aerial feature of the positive example image that is a combination of the aerial image feature of the positive example image, the features of the segmented image of the positive example image, and the features of the keyword matrix of the positive example image.

Similarly, the training apparatus inputs the negative example image, the segmented image of the negative example image, and the keyword matrix of the negative example image into the network 130, 140, and 150, respectively. As a result, the training apparatus obtains the aerial feature of the negative example image that is a combination of the aerial image feature of the negative example image, the features of the segmented image of the negative example image, and the features of the keyword matrix of the negative example image.

The training apparatus computes a triplet loss based on the ground feature of the anchor image, the aerial feature of the positive example image, and the aerial feature of the negative example. Then, the training apparatus updates trainable parameters of the models based on the obtained triplet loss. It is noted that there are various wall-known ways to update trainable parameters of one or more machine learning-based models based on a triplet loss computed based on the outputs from those models, and any one of them can be employed in the training apparatus.

It is also noted that a triplet loss is a merely example of a loss capable of being used to train the models, and any other types of loss may be used to train the models.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

### SUPPLEMENTARY NOTES

### Supplementary Note 1

An image matching apparatus comprising:
at least one memory that is configured to store instructions; and
at least one processor that is configured to execute the instructions to:
acquire a ground-view image, an aerial-view image, and class information that indicates a distribution of classes of objects on the ground-view image, the aerial-view image, or both;
extract features from the ground-view image to compute a ground image feature;
extract features from the aerial-view image to compute an aerial image feature;
extract features from the class information to compute a class feature; and
determine whether or not the ground-view image and the aerial-view image match each other based on the ground image feature, the aerial image feature, and the class feature.

### Supplementary Note 2

The image matching apparatus according to supplementary note 1,
wherein the class information includes a segmented image each of whose pixel indicates the class of the object captured in one or more corresponding pixels of the ground-view image or the aerial-view image.

### Supplementary Note 3

The image matching apparatus according to supplementary note 1,
wherein the class information includes a keyword matrix each of whose element indicates a keyword vector that is assigned to the class of the object captured in one or more corresponding pixels of the ground-view image or the aerial-view image.

### Supplementary Note 4

The image matching apparatus according to supplementary note 3,
wherein the keyword vectors are defined to represent similarity between classes by distance between the keyword vectors corresponding to those classes.

### Supplementary Note 5

The image matching apparatus according to any one of supplementary notes 1 to 4,
wherein the determination of whether or not the ground-view image and the aerial-view image match each other includes:
   computing similarity between a ground image feature and an aerial image feature; and
   determining that the ground-view image and the aerial-view image match each other when the computed similarity is larger than or equal to a predetermined threshold,
when the class information includes ground class information that indicates the distribution of classes of objects on the ground-view image, the ground feature is a combination of the ground image feature and the class feature extracted from the ground class information,
when the class information includes aerial class information that indicates the distribution of classes of objects on the aerial-view image, the aerial feature is a combination of the aerial image feature and the class feature extracted from the aerial class information.

### Supplementary Note 6

An image matching method performed by a computer, comprising:
acquiring a ground-view image, an aerial-view image, and class information that indicates a distribution of classes of objects on the ground-view image, the aerial-view image, or both;
extracting features from the ground-view image to compute a ground image feature;
extracting features from the aerial-view image to compute an aerial image feature;
extracting features from the class information to compute a class feature; and
determining whether or not the ground-view image and the aerial-view image match each other based on the ground image feature, the aerial image feature, and the class feature.

### Supplementary Note 7

The image matching method according to supplementary note 6,
wherein the class information includes a segmented image each of whose pixel indicates the class of the object captured in one or more corresponding pixels of the ground-view image or the aerial-view image.

### Supplementary Note 8

The image matching method according to supplementary note 6,
wherein the class information includes a keyword matrix each of whose element indicates a keyword vector that is assigned to the class of the object captured in one or more corresponding pixels of the ground-view image or the aerial-view image.

### Supplementary Note 9

The image matching method according to supplementary note 8,
wherein the keyword vectors are defined to represent similarity between classes by distance between the keyword vectors corresponding to those classes.

### Supplementary Note 10

The image matching method according to any one of supplementary notes 6 to 9,
wherein the determination of whether or not the ground-view image and the aerial-view image match each other includes:
   computing similarity between a ground image feature and an aerial image feature; and
   determining that the ground-view image and the aerial-view image match each other when the computed similarity is larger than or equal to a predetermined threshold,
when the class information includes ground class information that indicates the distribution of classes of objects on the ground-view image, the ground feature is a combination of the ground image feature and the class feature extracted from the ground class information,
when the class information includes aerial class information that indicates the distribution of classes of objects on the aerial-view image, the aerial feature is a combination of the aerial image feature and the class feature extracted from the aerial class information.

### Supplementary Note 11

A non-transitory computer-readable storage medium storing a program that causes a computer to execute:
acquiring a ground-view image, an aerial-view image, and class information that indicates a distribution of classes of objects on the ground-view image, the aerial-view image, or both;
extracting features from the ground-view image to compute a ground image feature;
extracting features from the aerial-view image to compute an aerial image feature;
extracting features from the class information to compute a class feature; and
determining whether or not the ground-view image and the aerial-view image match each other based on the ground image feature, the aerial image feature, and the class feature.

### Supplementary Note 12

The storage medium according to supplementary note 11,
wherein the class information includes a segmented image each of whose pixel indicates the class of the object captured in one or more corresponding pixels of the ground-view image or the aerial-view image.

### Supplementary Note 13

The storage medium according to supplementary note 11,
wherein the class information includes a keyword matrix each of whose element indicates a keyword vector that is assigned to the class of the object captured in one or more corresponding pixels of the ground-view image or the aerial-view image.

### Supplementary Note 14

The storage medium according to supplementary note 13,
wherein the keyword vectors are defined to represent similarity between classes by distance between the keyword vectors corresponding to those classes.

### Supplementary Note 15

The storage medium according to any one of supplementary notes 11 to 14,
wherein the determination of whether or not the ground-view image and the aerial-view image match each other includes:
   computing similarity between a ground image feature and an aerial image feature; and
   determining that the ground-view image and the aerial-view image match each other when the computed similarity is larger than or equal to a predetermined threshold,
when the class information includes ground class information that indicates the distribution of classes of objects on the ground-view image, the ground feature is a combination of the ground image feature and the class feature extracted from the ground class information,
when the class information includes aerial class information that indicates the distribution of classes of objects on the aerial-view image, the aerial feature is a combination of the aerial image feature and the class feature extracted from the aerial class information.

### REFERENCE SIGNS LIST

20 ground-view image
22 segmented image of ground-view image
24 keyword matrix of ground-view image
30 aerial-view image
32 segmented image of aerial-view image
34 keyword matrix of aerial-view image
40 class information
60 ground image feature
65 ground feature
70 aerial image feature
75 aerial feature
80 class feature
100, 110, 120, 130, 140, 150 network
160, 170, 180, 190 features
200 geo-localization system
300 location database
1000 computer
1020 bus
1040 processor
1060 memory
1080 storage device
1100 input/output interface
1120 network interface
2000 image matching apparatus
2020 acquisition unit
2040 ground image feature extraction unit
2060 aerial image feature extraction unit
2080 class feature extraction unit
2100 determination unit

What is claimed is:

1. An image matching apparatus comprising:
at least one memory that is configured to store instructions; and
at least one processor that is configured to execute the instructions to:
acquire a ground-view image, an aerial-view image, and class information that indicates a distribution of classes of objects on the ground-view image, the aerial-view image, or both;
extract features from the ground-view image to compute a ground image feature;
extract features from the aerial-view image to compute an aerial image feature;
extract features from the class information to compute a class feature; and
determine whether or not the ground-view image and the aerial-view image match each other based on the ground image feature, the aerial image feature, and the class feature.

2. The image matching apparatus according to claim 1,
wherein the class information includes a segmented image each of whose pixel indicates the class of the object captured in one or more corresponding pixels of the ground-view image or the aerial-view image.

3. The image matching apparatus according to claim 1,
wherein the class information includes a keyword matrix each of whose element indicates a keyword vector that is assigned to the class of the object captured in one or more corresponding pixels of the ground-view image or the aerial-view image.

4. The image matching apparatus according to claim 3,
wherein the keyword vectors are defined to represent similarity between classes by distance between the keyword vectors corresponding to those classes.

5. The image matching apparatus according to claim 1,
wherein the determination of whether or not the ground-view image and the aerial-view image match each other includes:
computing similarity between a ground feature and an aerial feature; and
determining that the ground-view image and the aerial-view image match each other when the computed similarity is larger than or equal to a predetermined threshold,
when the class information includes ground class information that indicates the distribution of classes of objects on the ground-view image, the ground feature is a combination of the ground image feature and the class feature extracted from the ground class information,
when the class information includes aerial class information that indicates the distribution of classes of objects on the aerial-view image, the aerial feature is a combination of the aerial image feature and the class feature extracted from the aerial class information.

6. An image matching method performed by a computer, comprising:
acquiring a ground-view image, an aerial-view image, and class information that indicates a distribution of classes of objects on the ground-view image, the aerial-view image, or both;
extracting features from the ground-view image to compute a ground image feature;
extracting features from the aerial-view image to compute an aerial image feature;
extracting features from the class information to compute a class feature; and
determining whether or not the ground-view image and the aerial-view image match each other based on the ground image feature, the aerial image feature, and the class feature.

7. The image matching method according to claim 6,
wherein the class information includes a segmented image each of whose pixel indicates the class of the object captured in one or more corresponding pixels of the ground-view image or the aerial-view image.

8. The image matching method according to claim 6,
wherein the class information includes a keyword matrix each of whose element indicates a keyword vector that is assigned to the class of the object captured in one or more corresponding pixels of the ground-view image or the aerial-view image.

9. The image matching method according to claim 8,
wherein the keyword vectors are defined to represent similarity between classes by distance between the keyword vectors corresponding to those classes.

10. The image matching method according to claim 6,
wherein the determination of whether or not the ground-view image and the aerial-view image match each other includes:
computing similarity between a ground feature and an aerial feature; and
determining that the ground-view image and the aerial-view image match each other when the computed similarity is larger than or equal to a predetermined threshold,
when the class information includes ground class information that indicates the distribution of classes of objects on the ground-view image, the ground feature is a combination of the ground image feature and the class feature extracted from the ground class information,
when the class information includes aerial class information that indicates the distribution of classes of objects on the aerial-view image, the aerial feature is a combination of the aerial image feature and the class feature extracted from the aerial class information.

11. A non-transitory computer-readable storage medium storing a program that causes a computer to execute:
acquiring a ground-view image, an aerial-view image, and class information that indicates a distribution of classes of objects on the ground-view image, the aerial-view image, or both;
extracting features from the ground-view image to compute a ground image feature;
extracting features from the aerial-view image to compute an aerial image feature;
extracting features from the class information to compute a class feature; and
determining whether or not the ground-view image and the aerial-view image match each other based on the ground image feature, the aerial image feature, and the class feature.

12. The storage medium according to claim 11,
wherein the class information includes a segmented image each of whose pixel indicates the class of the object captured in one or more corresponding pixels of the ground-view image or the aerial-view image.

13. The storage medium according to claim 11,
wherein the class information includes a keyword matrix each of whose element indicates a keyword vector that is assigned to the class of the object captured in one or more corresponding pixels of the ground-view image or the aerial-view image.

14. The storage medium according to claim 13,
wherein the keyword vectors are defined to represent similarity between classes by distance between the keyword vectors corresponding to those classes.

15. The storage medium according to claim 11,
wherein the determination of whether or not the ground-view image and the aerial-view image match each other includes:
computing similarity between a ground feature and an aerial feature; and
determining that the ground-view image and the aerial-view image match each other when the computed similarity is larger than or equal to a predetermined threshold,
when the class information includes ground class information that indicates the distribution of classes of objects on the ground-view image, the ground feature is a combination of the ground image feature and the class feature extracted from the ground class information,
when the class information includes aerial class information that indicates the distribution of classes of objects on the aerial-view image, the aerial feature is a combination of the aerial image feature and the class feature extracted from the aerial class information.
